(19) United States
(12) Patent Application Publication
(10) Pub. No.: US 2008/0235302 A1
(43) Pub. Date: Sep. 25, 2008

(54) TRANSPARENT ALLOCATION OF A UNIQUE PER USER/TMP FS

(76) Inventors: Rhonda L. Childress, Austin, TX (US); Oded Dubovsky, Haifa (IL); Itzhack Goldberg, Hativat Givati (IL); Ido Levy, Kiryat Mozkin (IL); Stephen J. Watt, Cedar Park, TX (US)

Correspondence Address: HOFFMAN WARNICK LLC, 75 STATE ST, 14TH FLOOR, ALBANY, NY, 12207, US

(21) Appl. No.: 11/687,869

(22) Filed: Mar. 19, 2007

(51) Int. Cl. G06F 12/00

(52) U.S. Cl. 707/205; 707/E17.01

(57) ABSTRACT

The invention is directed to the transparent allocation of a unique per user /tmp file system. A method in accordance with an embodiment of the present invention includes: manipulating an operating system to provide each user with a private temporary file system; and constraining a process of the user to the user's private temporary file system.

### BACKGROUND OF THE INVENTION

1. Field of the Invention

The present invention generally relates to file systems. More specifically, the present invention is directed to the transparent allocation of a unique per user /tmp file system.

2. Related Art

Sharing the /tmp directory among all users on a traditional operating system (OS), such as the Unix OS, is known to be a vulnerability of the system. Many system utilities and user applications, such as editors, use by default the /tmp directory (or its equivalent) as a repository for transient directories and files. Any such process which goes astray can fill the /tmp directory to the hilt and have an adverse affect on other user applications and processes.

It is possible to utilize a quota mechanism to restrict each user to a maximum amount of storage space on any particular file system (FS). Such an approach, however, would require a number of trial and error attempts to determine the profile of each user's applications and the best, average, and worse case scenarios. Even then, under certain circumstances, processes could be denied disk space even though they were completely “healthy.” Further, using quota control requires the system to monitor space usage on on-going basis, which takes a processing toll on the system.

When disk space was an expensive resource, the design of an OS with a common shared /tmp directory was justified. Today, however, disks are much more inexpensive, and there is generally no need to maintain that approach. If each user could have their own /tmp file-system, then at worst, any unruly process would have ill effects only on the respective user's processes, while other users' processes will not suffer at all. Unfortunately there are so many legacy utilities and applications that depend of the presence of the /tmp directory that any such solution would have to be backward compatible.

### SUMMARY OF THE INVENTION

The present invention is directed the transparent allocation of a unique per user /tmp file system.

One aspect of the invention is directed to a method for transparently allocating a unique per user temporary file system, comprising: manipulating an operating system to provide each user with a private temporary file system; and constraining a process of the user to the user's private temporary file system.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings in which:

FIGS. 1 and 2 depict illustrative processes in accordance with embodiment(s) of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

As described above, the present invention is directed to the transparent allocation of a unique per user /tmp file system. An existing OS is manipulated to provide each user with a private /tmp file, such that each user cannot “hog” a shared /tmp file or some other user's /tmp file.

In accordance with the present invention, commands and techniques are used to create an “execution environment.” This “environment” shares the same resources on the system as the stock OS, with the exception of a “private”/tmp directory. The commands used are privileged commands, such as exec, mount, chroot, etc., which have to be exercised by ‘root’ during a user's login session prior to activating the user's favorite shell command.

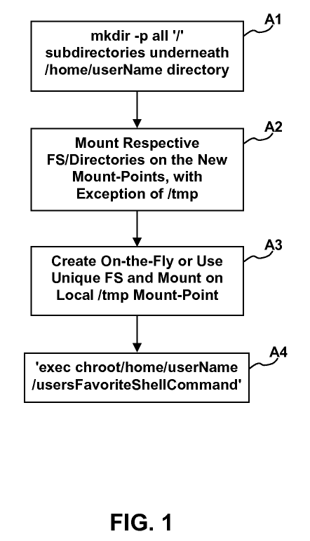

In accordance with the present invention, as depicted in FIG. 1, the following general process is carried out: (A1) mkdir -p (make directory) all of the ‘/’ subdirectories underneath the /home/userName directory; (A2) mount the respective FS/directories on these new mount-points, with the exception of /tmp; (A3) create on-the-fly or use a unique FS and mount it on the local /tmp mount-point; and (A4) execute ‘chroot/home/userName/usersFavoriteShellCommand’ to change the root directory. In this way, the user has his/her own environment and they are tied to it. Upon exit, the user logs off the session.

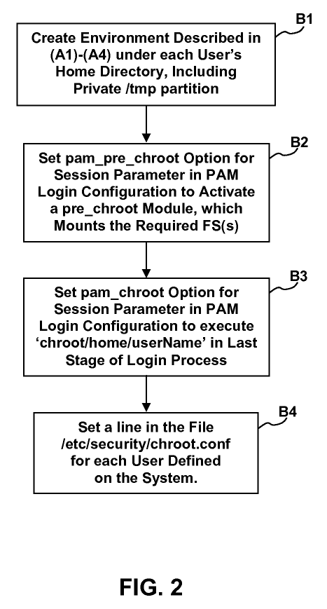

An illustrative implementation of the present invention is described below with regard to FIG. 2. In order to set the above-described environment on, for example, a Linux machine, one can perform the following:

(B1) Create under each user's home directory the environment described above in (A1)-(A4), including the private /tmp partition.
(B2) In the Pluggable Authentication Module (PAM) login configuration, set the pam_pre_chroot option for the session parameter. This option activates a pre_chroot module which mounts the required FS(s).
(B3) In the PAM login configuration, set the pam_chroot option for the session parameter. This option causes execution of ‘chroot/home/userName’ in the last stage of the login process.
(B4) Set a line in the file /etc/security/chroot.conf for each user defined on the system.
At this stage every user (per the chroot.conf) who logs into the machine will see the root of the file system as /home/username.

The above-described process can be used in a similar manner to implement the present invention for other open-source and non-open-source OSs. One reason is that the infrastructure (e.g., the PAM) is available for most OSs. As such, one would be able to easily write/port the above-described implementation to another OS.

It should be noted that (A1) to (A4) and (B1-B4) are intended to represent method steps, system components, and/or program code configured to implement the present invention.

Some/all aspects of the present invention can be provided on a computer-readable medium that includes computer program code for carrying out and/or implementing the various process steps of the present invention, when loaded and executed in a computer system. It is understood that the term “computer-readable medium” comprises one or more of any type of physical embodiment of the computer program code. For example, the computer-readable medium can comprise computer program code embodied on one or more portable storage articles of manufacture (e.g., a compact disc, a magnetic disk, a tape, etc.), on one or more data storage portions of a computer system, such as memory and/or a storage system (e.g., a fixed disk, a read-only memory, a random access memory, a cache memory, etc.), and/or as a data signal traveling over a network (e.g., during a wired/wireless electronic distribution of the computer program code).

It should be appreciated that the teachings of the present invention could be offered as a business method on a subscription or fee basis. For example, a service provider can create, maintain, enable, and deploy an audience response detection interactive presentation tool, as described above.

The foregoing description of the embodiments of this invention has been presented for purposes of illustration and description. It is not intended to be exhaustive or to limit the invention to the precise form disclosed, and many modifications and variations are possible.

What is claimed is:

1. A method for transparently allocating a unique per user temporary file system, comprising:
manipulating an operating system to provide each user with a private temporary file /tmp; and
constraining a process of the user to the user's private temporary file /tmp.

2. The method of claim 1, wherein the manipulating further comprises:
making a directory of all subdirectories underneath a /home/userName directory of the user;
mounting a respective directory on each new mount-point, with exception of the user's /tmp;
create or use a unique file system and mount it on a mount-point of the user's /tmp; and
change a root directory of the user based on /home/userName.

3. The method of claim 2, wherein an execution environment is created which shares resources on a system, with exception of the user's /tmp.
